(19) United States
(12) Patent Application Publication
(10) Pub. No.: US 2011/0137304 A1
(43) Pub. Date: Jun. 9, 2011

(54) CRYOTHERAPY DEVICE FOR TREATMENT OR PREVENTION OF LAMINITIS IN EQUINE

(76) Inventors: Larry Brook Mayberry, Edmond, OK (US); Dynah E. Korhummel, Norman, OK (US); Randy Marler, Norman, OK (US); M. Mark Williams, Dallas, TX (US); Raymond J. Young, Norman, OK (US)

(21) Appl. No.: 12/633,320

(22) Filed: Dec. 8, 2009

(51) Int. Cl. A01L 15/00

(52) U.S. Cl. 606/22; 607/104

(57) ABSTRACT

An apparatus for providing cryotherapy to an equine hoof for treatment or prevention of laminitis includes a housing configured to receive a hoof of the equine having laminitis such that at least a lower portion of the hoof is enclosed by the housing. The housing has a chamber within, in communication with a source of cooling fluid. The housing may be supported in a boot. A heat transfer surface of the housing delivers cooling to a sole area of the equine hoof, thereby treating or preventing laminitis, for example, without directly contacting the hoof with fluid. Tubing for flow of cooling fluid to and from the chamber extends upwardly along each of the legs of the equine being treated to prevent crimping or entanglement of the tubing due to movement of the equine.

### CROSS REFERENCE TO RELATED APPLICATIONS

Not Applicable.

### STATEMENT REGARDING FEDERALLY SPONSORED RESEARCH OR DEVELOPMENT

Not applicable.

### BACKGROUND

1. Field of Invention

The present invention relates generally to a cryotherapy device and, more particularly, but not by way of limitation, to a cryotherapy device for providing dry cooling to the sole area of an equine hoof for treatment or prevention of laminitis.

2. Background of the Invention

Equine laminitis is a crippling disease that affects the feet of horses and other equine. It is basically a failure in the attachment of the pedal bone, also referred to as the coffin bone, to the inner hoof wall. The pedal bone is attached to the inner hoof wall by two interlocking layers of laminae. Laminitis causes inflammation of these laminae that can result in structural failure of the attachment holding the horse's hoof onto the pedal bone. One way to treat both early and acute inflammation is with cold therapy. Cold therapy reduces inflammation and pain in three basic ways.

First, cold therapy reduces pain by reducing nerve conduction velocity, or analgesia. The chilled area becomes less sensitive and takes longer to become sensitive again after being stimulated (increased refractory period). (See Douglas W W, Malcom J L: The effect of localized cooling on mammalian muscle spindles. J Physiol 130:53-71, 1955).

Hypometabolism is a second way in which cold therapy reduces inflammation. The rate of metabolism varies with temperature (see, for example, Gillooly J F, Brown J H, West G B: Effects of size and temperature on metabolic rate. Science vol. 293 no. 5538, 2248-2251, 2001) and so does the rate of some inflammatory processes. Slowing cell metabolism with cold therapy reduces the nutrients needed by cells, allowing them to survive longer when nutrient supply is limited (as may occur with poor circulation, i.e., from swelling). Also, the activity of some inflammatory enzymes and possibly other mediators is reduced with cold temperatures, thus reducing the damage they may inflict on the laminae (see, for example, Van Eps A W, Walters L J, Baldwin G I. Distal Limb Cryotherapy for the Prevention of Acute Laminitis, Clinical Techniques in Equine Practice 3:64-70, 2004).

Finally, vasoconstriction reduces blood perfusion to the treated area (see Knight K L: Circulatory effects of therapeutic cold applications, in Knight K L (ed): Cryotherapy in Sport Injury Management, Champaign, Ill., Human Kinetics, 1995, pp. 107-126). This may be particularly useful in cases of laminitis due to systemic blood-borne laminitis trigger factors, such as feed overload or colitis cases. Reduction in blood flow to the hoof would reduce delivery of the trigger factors.

Although humans tend to experience some degree of pain with prolonged cryotherapy, this does not appear to occur with horses. In one study, horses tolerated standing in a water/ice slurry for 48 hours with no apparent clinical ill-effects during or following treatment. (See Pollitt C C, van Eps A W: Prolonged, continuous distal limb cryotherapy in the horse. Equine Vet J 36:216-220, 2004). This result is unsurprising considering horses living in harsh winter climates do not seem to have a problem with standing in snow for months on end.

Research has conclusively shown that cold therapy can significantly reduce the severity of laminitis when applied properly in a timely fashion, and in some cases may even fully prevent tissue damage. Van Eps et al. found that when one limb on each study horse was immersed in ice/water slurry for 48 hours immediately following induction of laminitis, the cooled limbs showed no tissue changes (2/6 horses) or minimal changes (4/6 horses). In contrast, the untreated limbs all developed mild to severe tissue changes and lameness.

Van Eps et al. also reported success with seven cases of acute colitis, one of which had elevated digital pulses prior to therapy. Cryotherapy was applied by keeping the horses standing with all four feet in a water/ice tub for 72-96 hours. Only the horse with previously elevated digital pulses was lame (Grade 2) 12-24 hours after cryotherapy was discontinued. All seven horses ultimately returned to full work at previous levels, with three winning races between discharge and acceptance of the paper. Despite the low numbers of cases reported, since laminitis was a complication in an estimated 40-50% of similar colitis cases, having long-term laminitis complications in zero cryotherapy cases is quite encouraging.

Van Eps et al. recommended cryotherapy for any horse at immediate risk of acute laminitis, such as those that have ingested excess carbohydrate, been exposed to black walnut shavings, or suffer from diseases such as colitis, proximal enteritis, metritis, pleuropneumonia, peritonitis, complicated colic, etc. Therapy should begin immediately, before lameness appears, as the whole idea is to prevent structural damage, rather than treat it. The recommended treatment regime is continuous cooling, not intermittent cooling, keeping the distal limb below 5° C. for 72 hours. It should be noted that after cryotherapy is discontinued, significant warming of the feet and increased digital pulses (reflex dilation) tends to occur after 12-24 hours; this should not be considered laminitis unless characteristic lameness also occurs.

Difficulties in applying cryotherapy to horses include the need to keep the horse standing continuously in the ice water and continuously replacing the ice to maintain the desired temperature. Additionally, while soaking a horse's hooves in water for 30 minutes or more is a common procedure, and while the horse can tolerate the cold for 48 hours or more, keeping the horse's feet in ice water for over 48 hours requires continuous supervision and can even lead to other problems such as thrush.

Thus, there is a need for improved cryotherapy methods, devices and apparatuses for applying cold to equine for treatment or prevention of laminitis.

### SUMMARY OF THE INVENTION

One embodiment of the present invention is directed to an apparatus for treatment or prevention of laminitis in equine. The apparatus comprises a housing configured to receive a hoof of an equine having laminitis such that at least a lower portion of the hoof of the equine is enclosed by the housing. Within the housing are a chamber, and an inlet and outlet that establish fluid communication between a source of cooling fluid and the chamber. A heat transfer wall is defined by an upper portion of the chamber, and inlet and outlet tubes are configured to provide an effective flow of cooling fluid through the chamber to cool a sole area of the equine hoof and thereby treat or prevent the laminitis in the equine. Optionally, a bladder is disposed within the chamber, the bladder configured to contain the cooling fluid within the chamber and to provide the inlet and outlet establishing fluid communication between the source of cooling fluid and the chamber.

In another embodiment, the apparatus for providing cryotherapy to an equine hoof for treatment or prevention of laminitis has a support assembly configured to receive a sole of the equine hoof, and including a housing, wherein the housing defines a recessed cavity extending from an upper surface of the housing. The support assembly further includes a heat transfer plate, wherein the plate and housing cooperate to define a chamber. An inlet and outlet are provided to the chamber for establishing fluid communication between a source of cooling fluid and the chamber. A heat exchanger for cooling the source of cooling fluid is adapted to provide an effective flow of cooling fluid through the chamber to cool a sole area of the equine hoof and thereby treat or prevent laminitis in the equine. Optionally, a bladder is disposed within the chamber, and the bladder is configured to contain the cooling fluid within the chamber and to provide the inlet and outlet establishing fluid communication between the source of cooling fluid and the chamber. The support assembly optionally includes a boot having the housing disposed within the boot.

Thus, utilizing (1) the technology known in the art; (2) the above-referenced general description of the presently claimed and/or disclosed inventive process(es), methodology(ies), apparatus(es) and composition(s); and (3) the detailed description of the invention that follows, the advantages and novelties of the presently claimed and/or disclosed inventive process(es), methodology(ies), and apparatus(es) would be readily apparent to one of ordinary skill in the art.

### BRIEF DESCRIPTION OF THE DRAWINGS

FIG. 1 shows the anatomy of a horse's hoof and leg.

FIG. 2 shows the underside of a horse's hoof.

FIG. 3A-3D are representations of a housing of the present disclosure showing various baffle configurations.

FIG. 4 is a representation of a housing according to one embodiment of the present disclosure.

FIG. 5 is a representation of a boot used in combination with the housing of FIG. 4.

FIG. 6 is a representation of the boot and housing of FIG. 3 fitted on a hoof of an equine.

FIG. 7 is a representation of a system for controlling the temperature of the sole area of an equine hoof.

### DETAILED DESCRIPTION OF THE INVENTION

Before explaining at least one embodiment of the invention in detail, it is to be understood that the invention is not limited in its application to the details of construction, experiments, exemplary data, and/or the arrangement of the components set forth in the following description. The invention is capable of other embodiments or of being practiced or carried out in various ways. Also, it is to be understood that the terminology employed herein is for purpose of description and should not be regarded as limiting.

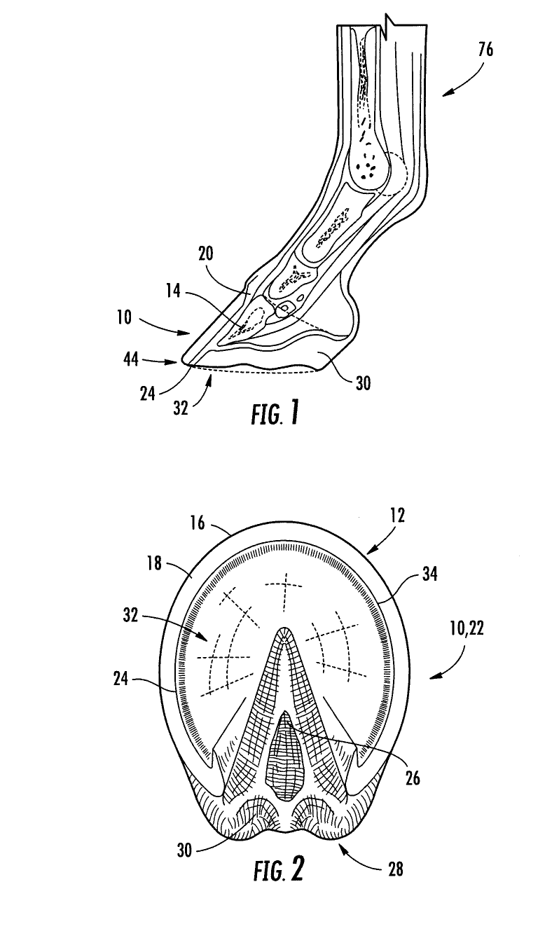

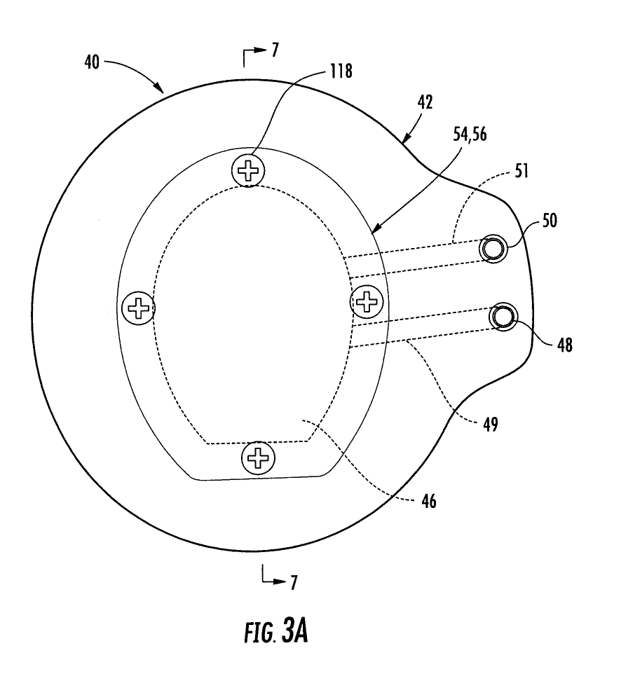

An equine hoof 10 is made of an outer hoof capsule 12 and inner living soft tissues and bone. The hoof capsule 12 covers, protects and supports the pedal bone 14, commonly referred to as the coffin bone, as shown in FIG. 1. The outer cover 16 includes a wall 18 that originates from the coronary band 20. Also shown are the cannon bone, long pastern, short pastern, deep flexor tendon, plantar cushion and navicular bone. When viewing the lower surface 22 of the hoof 10, as shown in FIG. 2, one can see that the wall 18 encircles most of the hoof 10. The “white line” 24 is an inner layer of the wall 18 that is fibrous in nature. The triangular area 26 extending from near the center of the lower surface 22 to the heel 28 is grooved, having a V-shape. The heel 28 is separated by an elastic structure called the frog 30. The lower surface 22 of the hoof 10, from the outer wall 18 to the frog 30, is covered by a keratinized material commonly called the sole. The entire lower surface 22 of the hoof 10, including the frog 30, is referred to herein and in the appended claims as the “sole area” 32.

The laminae 34 form a vascularized layer between the wall 18 and the pedal bone 14, so named because the layer has a laminar shape. The laminar connection is very important in determining the strength and the health of the hoof 10. The laminae 34 are responsible for suspension of the skeleton within the hoof 10 and they dissipate concussive forces when the animal walks or runs. There are about 600 pairs of interlocking laminae: one set attached to the hoof wall and another set attached to the coffin bone. Laminitis results when the interaction between the set fails. The area becomes inflamed and congested with blood, causing severe pain. The term “laminitis” literally means inflammation of the laminae. If the problem is not addressed, the coffin bone will detach itself from the hoof wall and rotate downwardly.

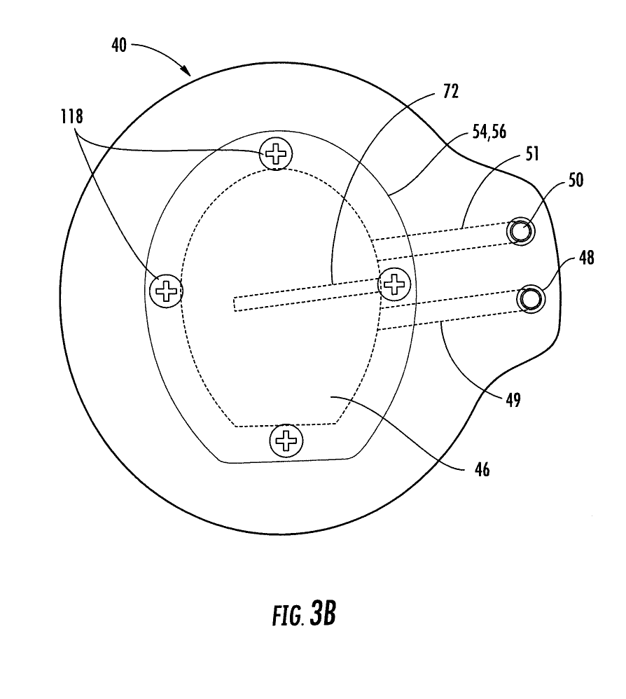

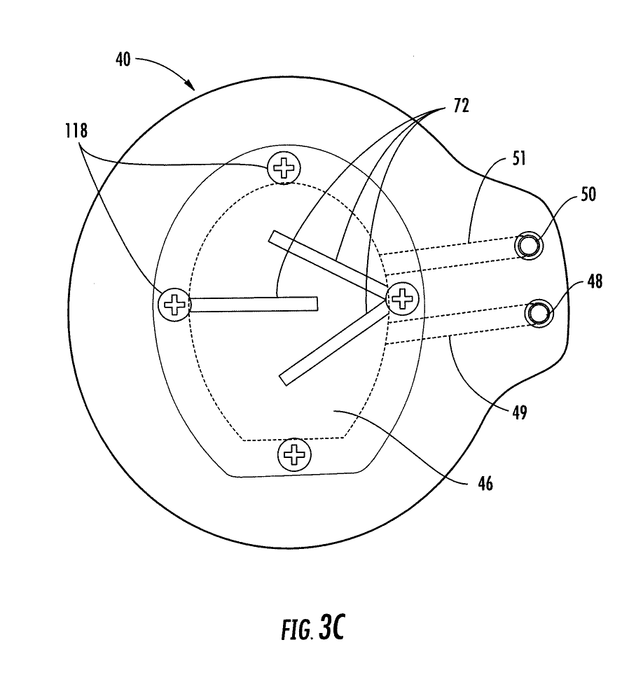

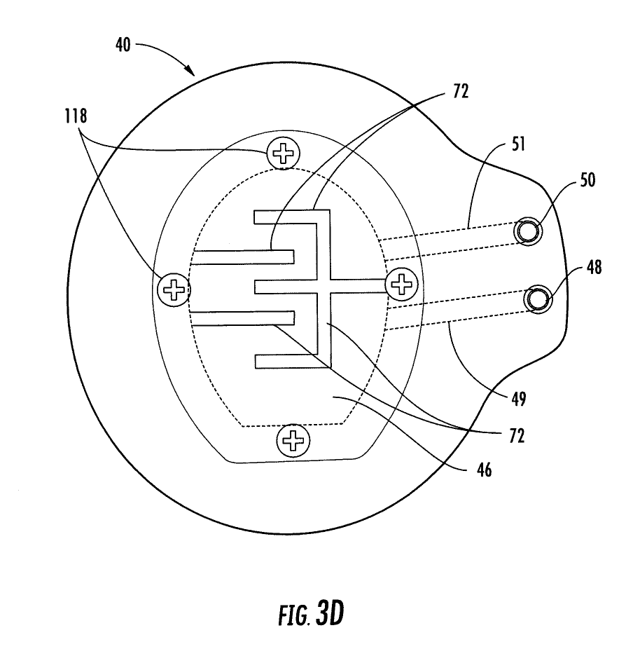

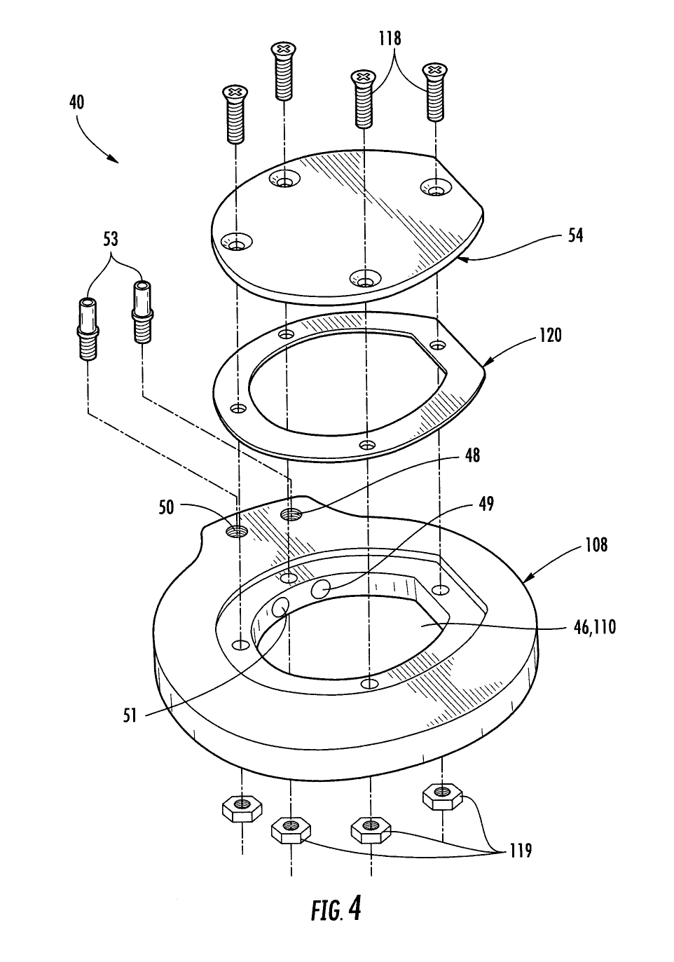

As mentioned above, research has shown that cryotherapy, also referred to herein as cold therapy, can significantly reduce the severity of laminitis when applied properly and in a timely fashion. In some cases, cryotherapy may even fully prevent tissue damage due to laminitis. Referring to FIG. 3A, in accordance with an aspect of the present invention, an apparatus 40 is provided for applying cryotherapy to an equine hoof 10, wherein the apparatus 40 comprises a housing 42 configured to receive a hoof 10 of an equine having laminitis such that at least a lower portion 44 of the hoof 10 of the equine is enclosed by the housing 42. A chamber 46 is provided within the housing 42 and a fluid inlet 48 and fluid outlet 50 are provided to establish fluid communication between a source of cooling fluid 52 and the chamber 46 via a fluid inlet passageway 49 and a fluid outlet passageway 51 utilizing, for example, nipples 53 to connect the fluid inlet 48 and fluid outlet 50 to an inlet tube 58 and an outlet tube 60, respectively. Optionally, the chamber 46 is provided with a pouch or bladder 102 (shown in FIG. 7) for holding the cooling fluid 52 within the chamber 46 and for providing the fluid inlet 48 and fluid outlet 50. A heat transfer wall 54 is defined by an upper portion 56 of the chamber 46. The inlet tube 58 and outlet tube 60 are configured to provide an effective flow of cooling fluid 62 through the chamber 46 such that heat from a sole area 32 of the equine hoof 10 is transferred through the heat transfer wall 54 to the cooling fluid 62. The amount of cooling provided can be controlled using a temperature sensor 36 input to a temperature controller 38. Thus the apparatus 40 provides cooling to the sole area 32 of the equine hoof 10 without directly exposing the hoof 10 to a liquid.

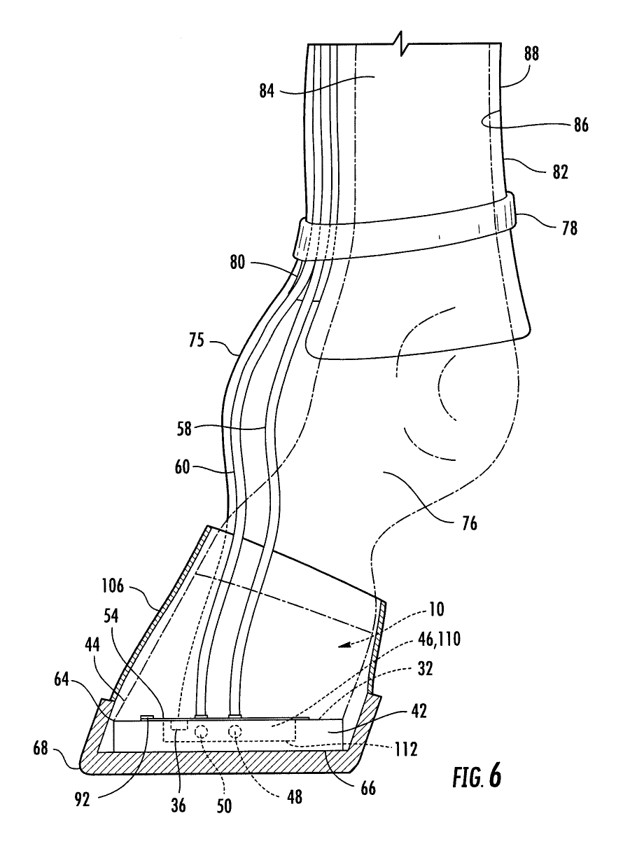

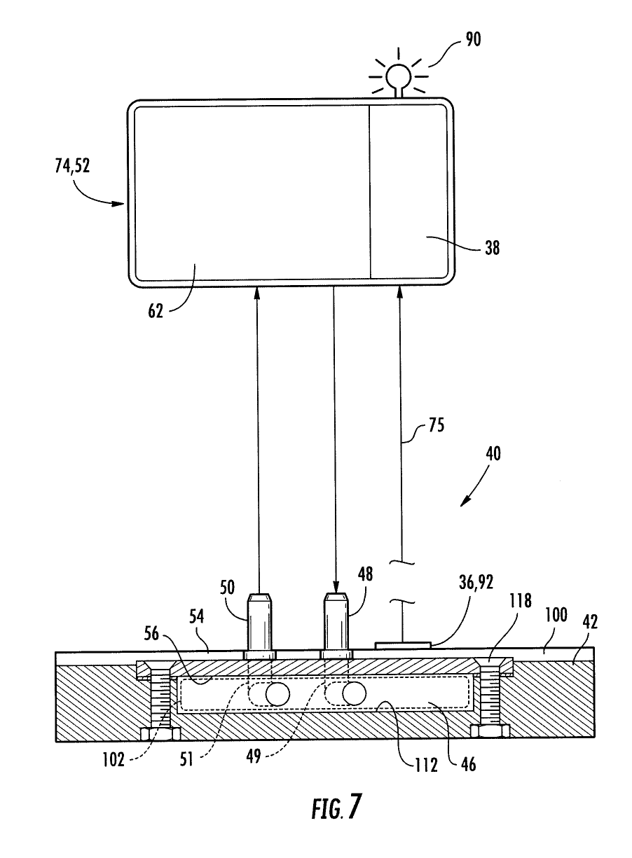

Optionally, the housing 42 is formed of a flexible and resilient material such as a hard gel, rubber or polymeric elastomer such as a polyurethane elastomer. An upper ridge 64 of the housing 42 shown in FIG. 6 is adapted to be fitted over the hoof wall 18. The thickness and elasticity of the upper ridge 64 should provide sufficient flexibility to allow the upper ridge 64 to be readily fitted over the hoof wall 18. However, the ridge 64 thickness and elasticity should also be sufficient to resist tearing when stretched and to resist movement when in its desired position on the hoof wall 18. The choice of material is well within the ability of those skilled in the polymer art to select.

The undersurface 66 of the housing 42 can be made sufficiently thick to provide a suitable surface for the animal to walk on. The undersurface 66 of the housing 42 can alternatively, or additionally, be protected by adding a tougher material such as a thermoplastic polyurethane outer sole 68 bonded or otherwise attached to the undersurface 66 of the housing 42. The housing undersurface 66 and/or the urethane outer sole 68 can be surfaced to provide traction and support for the equine.

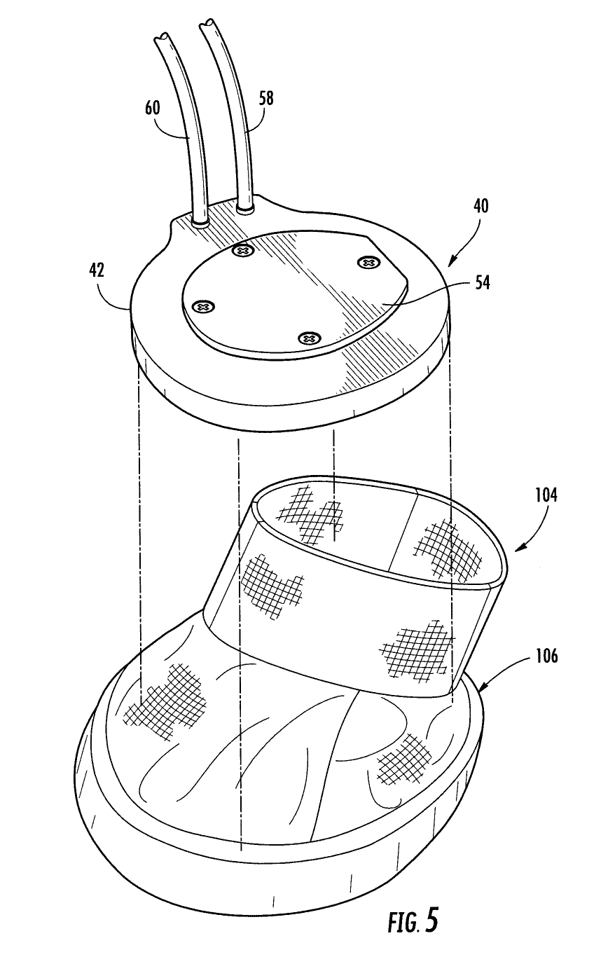

In one embodiment, the housing 42 is form-fitted to the hoof 10 of the equine to provide a substantially air-tight connection between the sole area 32 of the equine hoof 10 and the heat transfer wall 54. The connection is considered substantially air-tight if the heat transfer due to mass transfer of air in and out of the area between the sole area 32 of the hoof 10 and the heat transfer wall 54 does not significantly affect the ability of the apparatus 40 to cool the sole area 32 of the hoof 10 to the desired temperature. The heat transfer wall 54 is shown as a separate attachment in FIG. 3A and FIG. 4; however, it can also be a continuous wall of the housing 42. In this case, the heat transfer wall 54 is sufficiently thin to provide heat transfer across the wall to enable cooling the equine hoof 10 to the desire temperature. Preferably, the sole area 32 of the equine is cooled to a temperature in the range of from about 0° C. to about 15° C. More preferably, the sole area 32 of the equine is cooled to a temperature in the range of from about 0° C. to about 5° C.

The chamber dimensions preferably follow roughly the undersurface area of the hoof 10 surrounded by the hoof wall 18, but can be smaller or larger. The height (or thickness) of the chamber 46 provides a chamber volume sufficient to cool the sole area 32 of the hoof 10 to the desired temperature without jeopardizing the structural integrity of the chamber 46 or housing 42. Preferably, the height of the chamber 46 is in a range of from about ⅛ inch to about 1 inch.

To reduce dead or stagnant spots within the chamber 46 and to reduce short circuiting of the cooling fluid 62 between the inlet 48 and outlet 50 of the chamber 46, one or more baffles 72 may be provided within the chamber 46. The baffles 72, as shown in FIGS. 3B-3D, provide a path for the flow of fluid 62 through the chamber 46. The baffles 72 may also assist in supporting and distributing the weight of the equine.

Referring to FIGS. 5 through 7, flexible tubing 58 and 60 connects the housing inlet 48 and outlet 50 to a heat exchanger or chiller 74. In this manner, a pump (not shown) can pump chilled fluid 62 from the source of cooling fluid 52 (chiller 74) through the flexible inlet tubing 58 to the inlet 48 of the housing chamber 46. The chilled cooling fluid 62 travels through the chamber 46, the chamber fluid outlet 50, and returns to the chiller 74 through the flexible outlet tubing 60. In this manner the temperature of the sole area 32 of the equine hoof 10 can be adjusted and controlled while maintaining the hoof 10 in a dry condition.

The inlet and outlet tubing 58 and 60, and optionally a thermocouple or temperature sensor wire 75, extend upwardly along a leg 76 of the equine being treated to prevent crimping or entanglement of the tubes 58 and 60 due to movement of the equine. In an embodiment of the present invention, the tubing 58 and 60 is secured to the equine leg 76 by, for example, straps 78. The straps 78 are preferably adapted to prevent direct contact of the tubing 58 and 60 with the equine. This can be accomplished, for example, by using a tubular cover 80 for the tubing 58 and 60 positioned proximate the area where the tubing 58 and 60 is secured to the equine leg 76. Numerous other means for insulating the tubing 58 and 60 are known and available.

A leg wrap 82 may also be used to provide additional cooling to the shank area 84 of the equine leg 76. In this instance, the tubing 58 and 60 may be secured to the wrap 82 and the wrap 82 acts to shield the leg 76 from direct contact with the tubing 58 and 60. The leg wrap 82 may also provide a source of cooling such as a conventional cold wrap, or it may be designed to make use of the tubing 58 and 60 and cooling fluid 62. For example, the tubing 60 returning to the heat exchanger 74 can be looped between an inner panel 86 and an outer panel 88 of the leg wrap 82 and secured by stitching or other suitable means compatible with the wrap material. The leg wrap 82 can be constructed in a manner similar to the wrap described in U.S. Pat. No. 5,167,227, the patent incorporated herein by reference. In this manner, the leg 76 can be cooled as well as the sole area 32 of the equine hoof 10.

Appropriate heat exchangers or chillers are available commercially and can be readily sized by those skilled in the art. For example, a chiller removes heat from a cooling fluid that enters the unit, and delivers refreshed cooling fluid to provide cooling to the sole area of the equine hoof. The chiller uses a liquid refrigerant or other working fluid to accomplish this task. The chiller lowers the temperature of the cooling fluid, such as water, polyglycol, or some other fluid, below that which could be obtained from ambient conditions. One type of a chiller is a flooded chiller. In typical flooded chiller applications, a plurality of heat transfer tubes is fully submerged in a pool of a two-phase boiling refrigerant. The refrigerant is often a chlorinated-fluorinated hydrocarbon (i.e., FREON®) having a specified boiling temperature. The cooling fluid enters the evaporator and is delivered to the plurality of tubes, which are submerged in a boiling liquid refrigerant. The cooling fluid passing through the plurality of tubes is chilled as it gives up its heat to the boiling refrigerant. The vapor from the boiling refrigerant is delivered to a compressor which compresses the vapor to a higher pressure and temperature. The high pressure and temperature vapor is then routed to a condenser where it is condensed for eventual return through an expansion device to the evaporator to lower the pressure and temperature. Those of ordinary skill in the art will appreciate that the foregoing occurs in keeping with the well-known refrigeration cycle.

Examples of suitable cooling fluids include, but are not limited to, water, saline solution, ethanol, glycol, and haloalkanes. The heat exchanger or chiller 74 can be placed above the ground or floor and out of the way of the equine.

The temperature sensor or thermocouple 36 can be inserted within the housing 42 for measuring the temperature of the cooling fluid 62 in the chamber 46. The temperature sensor 36 is preferably positioned between the sole area 32 of the equine hoof 10 being treated and the heat transfer wall 54. Also, a temperature sensor 36 can be positioned on an external surface of the hoof wall 18. An electrical connection or wire 75 between the temperature sensor(s) 36 and the controller 38 for the heat exchanger or chiller 74 can extend upwardly along the leg 76 of the equine being treated in a manner similar to the tubing. As understood by those skilled in the art, input from the temperature sensor(s) 36 can optionally be transmitted wirelessly to the controller 38. Output from the temperature sensor 36 can be utilized by the controller 38 to operate the heat exchanger or chiller 74 in a manner to control the temperature of the sole area 32 of the equine hoof 10 within a predetermined temperature range. The controller 38 can also be equipped with an alarm 90 indicating a temperature outside the control limits. A conductivity measuring device 92 can also be inserted, optionally along with the temperature sensor, between for example the sole area 32 of the equine hoof 10 being treated and the heat transfer wall 54, to alert if liquid enters the sole area 32 of the equine hoof 10.

In one embodiment, an insert 100 is positioned between the sole 32 and the heat transfer wall 54, the insert 100 having sufficient thermal conductivity to provide cooling of hoof surfaces in contact with the insert 100 due to heat transfer to/from the heat transfer wall 54. Preferably the insert 100 is formed of a putty type material, i.e., a material which is formable in shape sometimes referred to as conformal, such that it can be fitted to the equine hoof 10. Selection of appropriate heat conducting formable materials and composite materials are well within the understanding of those skilled in the art.

In another embodiment, an insert 100 is positioned between the sole area 32 and hoof wall 18 to facilitate rotation of the coffin bone 14 into the proper alignment. Preferably, the insert 100 is made of material(s) having sufficient thermal conductivity to provide cooling of hoof surfaces in contact with the insert 100 due to heat transfer to/from the heat transfer wall 54. The insert 100 can be solid or, alternatively, can be a pouch containing a liquid, frozen liquid, or gel.

In yet another embodiment, the apparatus 40 for providing cryotherapy to an equine hoof 10 for treatment or prevention of laminitis has a support assembly 104 configured to receive a sole area 32 of the equine hoof 10, and the support assembly 104 includes a boot 106 as shown in FIG. 5, wherein the housing 42 is disposed within the boot 106. The housing 42 defines a recessed cavity 110 extending from an upper surface 112 of the housing 42, and a heat transfer wall 54, in this case a heat transfer plate, wherein the plate 54 and housing 42 cooperate to define a chamber 46. Optionally, the chamber 46 is provided with a pouch or bladder 102 for holding the cooling fluid 52 within the chamber 46 and for providing the fluid inlet 48 and fluid outlet 50.

The boot 106 is made of any suitable flexible material, such as leather, woven or non-woven fabric. The housing 42 can be fabricated of an inelastic material because the boot 106 provides the necessary resilience for the equine. The heat transfer plate 54 is attached to the housing 42 using connectors or bolts 118 and nuts 119 as shown in FIG. 4. A gasket or sealant 120 can be used to maintain the chamber 46 fluid-tight.

The heat transfer plate 54 is fabricated of a material capable of transferring heat from the sole area 32 of the hoof 10 to the cooling fluid 62 within the chamber 46. Suitable examples of materials for construction of the heat transfer plate 54 include, but are not limited to, metals such as aluminum, copper, nickel or stainless steel. Preferably, the heat transfer plate 54 comprises aluminum.

While the above description has been directed to treatment or prevention of a single hoof 10, it is understood that two, three and preferably all four hooves of the equine would be treated using the inventive apparatus 40. Such a method for treating an equine having laminitis includes fitting a housing 42 of the present invention on each of four hooves 10 of the equine. The housings 42 can be single units or fitted into boots as described above. Tubing 58 and 60 is made to extend upwardly from each hoof 10 to the chiller 74. The chiller 74 is controlled to maintain a temperature in the range of from about 0° C. to about 15° C. for a period of 48 hours up to two weeks or until the conditions of laminitis are no longer present in the equine.

From the above description, it is clear that the present inventive process(es), methodology(ies), apparatus(es) and composition(s) are well adapted to carry out the objects and to attain the advantages mentioned herein as well as those inherent in the presently provided disclosure. While presently preferred embodiments of the invention have been described for purposes of this disclosure, it will be understood that numerous changes may be made which will readily suggest themselves to those skilled in the art and which are accomplished within the spirit of the presently claimed and disclosed inventive process(es), methodology(ies), apparatus(es) and composition(s) described herein.

What is claimed is:

1. An apparatus for the treatment or prevention of laminitis in equine comprising:
a housing configured to receive a hoof of an equine such that at least a lower portion of the hoof of the equine is enclosed by the housing, the housing having a chamber within, and an inlet and outlet establishing fluid communication between a source of cooling fluid and the chamber;
a heat transfer wall defined by an upper portion of the chamber; and
inlet and outlet tubes connected to the inlet and outlet, respectively, and configured to provide an effective flow of cooling fluid through the chamber to cool a sole area of the equine hoof.

2. The apparatus of claim 1, wherein the housing is form-fitted to the hoof of the equine to provide a substantially air-tight connection between the sole area of the equine hoof and the heat transfer wall.

3. The apparatus of claim 1, wherein the housing is formed of a flexible polymeric material.

4. The apparatus of claim 1, wherein the housing is formed of rubber.

5. The apparatus of claim 1, wherein the chamber within the housing comprises one or more baffles to reduce short circuiting of the cooling fluid between the inlet and outlet tubes.

6. The apparatus of claim 1, further comprising a bladder within the chamber, the bladder configured to contain the cooling fluid within the chamber and to provide the inlet and outlet establishing fluid communication between the source of cooling fluid and the chamber.

7. The apparatus of claim 1, wherein the source of cooling fluid comprises a heat exchanger.

8. The apparatus of claim 7, wherein the cooling fluid comprises a glycol.

9. The apparatus of claim 1, wherein the inlet tube and outlet tube extend upwardly along a leg of the equine to prevent crimping or entanglement of the tubes due to movement of the equine.

10. The apparatus of claim 9 further comprising straps for securing the inlet tube and the outlet tube to the leg of the equine.

11. The apparatus of claim 9 further comprising a leg wrap for minimizing contact between the equine leg and the inlet and outlet tubes.

12. The apparatus of claim 11, wherein the leg wrap includes a source of cooling configured to provide cooling to the leg.

13. The apparatus of claim 1, further comprising a temperature sensor inserted within the housing for measuring the temperature of the cooling fluid in the chamber.

14. The apparatus of claim 1, further comprising a temperature sensor inserted between a sole area of the equine hoof and the heat transfer wall for measuring the temperature of the sole area of the equine hoof.

15. The apparatus of claim 1, wherein the apparatus further comprises a thermocouple positioned between a sole area of the equine hoof and the heat transfer wall, and the source of cooling fluid comprises a heat exchanger and a controller, in wired or wireless connection with the thermocouple, for controlling the temperature of the sole area of the equine hoof within a predetermined temperature.

16. The apparatus of claim 15, wherein the predetermined temperature range is about 0° C. to about 15° C.

17. An apparatus for providing cryotherapy to an equine hoof for treatment or prevention of laminitis, the apparatus comprising:
a support assembly configured to receive a sole area of the equine hoof, the support assembly comprising a housing defining a recessed cavity extending from an upper surface of the housing, and a heat transfer plate, the plate and housing cooperating to define a chamber;
an inlet provided in the chamber for establishing fluid communication between a source of cooling fluid and the chamber;
an outlet provided in the chamber for establishing fluid communication between the source of cooling fluid and the chamber; and
a heat exchanger for cooling the source of cooling fluid to provide an effective flow of cooling fluid through the chamber to cool the sole area of the equine hoof.

18. The apparatus of claim 17, further comprising a bladder within the chamber, the bladder configured to contain the cooling fluid within the chamber and to provide the inlet and outlet establishing fluid communication between the source of cooling fluid and the chamber.

19. The apparatus of claim 17, further comprising a boot, wherein the housing is disposed within the boot and the boot is positionable about the hoof of the equine.

20. The apparatus of claim 17, wherein the housing is fabricated of an inelastic polymer.

21. The apparatus of claim 17, wherein the heat transfer plate is fabricated of a material effective for transferring heat from the sole area of the equine hoof to a cooling fluid within the chamber.

22. The apparatus of claim 17, wherein the heat transfer plate is fabricated of a material comprising a metal selected from the group consisting of aluminum, copper, nickel or stainless steel.

23. An apparatus for providing cryotherapy to an equine hoof for treatment or prevention of laminitis, the apparatus comprising:
a support assembly configured to receive a sole area of the equine hoof, the support assembly comprising a boot having a housing disposed within the boot, the boot positionable about the hoof of the equine, the housing defining a recessed cavity extending from an upper surface of the housing, and a heat transfer plate, the plate and housing cooperating to define a chamber, the chamber including a bladder configured to contain the cooling fluid within the chamber;
an inlet provided in the chamber for establishing fluid communication between a source of cooling fluid and the bladder;
an outlet provided in the housing for establishing fluid communication between the source of cooling fluid and the bladder; and
a heat exchanger for cooling the source of cooling fluid to provide an effective flow of cooling fluid through the chamber to cool a sole area of the equine hoof.
